(19) United States
(12) Patent Application Publication
(10) Pub. No.: US 2006/0125247 A1
(43) Pub. Date: Jun. 15, 2006

(54) Moisture resistant wall mounted door holder

(76) Inventor: Andrea Furia, Downey, CA (US)

Correspondence Address: AVERILL & VARN, 8244 PAINTER AVE., WHITTIER, CA, 90602, US

(21) Appl. No.: 11/267,075

(22) Filed: Nov. 4, 2005

Related U.S. Application Data
(63) Continuation-in-part of application No. 11/013,037, filed on Dec. 11, 2004.

(51) Int. Cl. E05C 19/16

(52) U.S. Cl. 292/251.5

(57) ABSTRACT

A moisture resistant electromagnetic door holder is sealed to avoid failures caused by exposure to moisture. The electromagnetic door holder comprises a wall box, a coil housing attached to the wall box, and a coil assembly attached to the coil housing. The coil assembly includes a bobbin containing a wire coil. A sealant, preferably epoxy, covers the face of the bobbin to prevent moisture from entering the coil assembly. A coil seal may be incorporated between a coil passage in the coil housing and the coil assembly. A gasket reside between the coil housing and the wall box. The resulting the electromagnetic door holder resists the entry of moisture into the electromagnetic door holder and thereby improves the reliability of the electromagnetic door holder.

The present application is a Continuation in Part of U.S. patent application Ser. No. 11/013,037, filed Dec. 11, 2004, which application is incorporated herein by reference.

### BACKGROUND OF THE INVENTION

The present invention relates to moisture resistant electrical devices and in particular to wall mounted moisture resistant electromagnetic door holders.

Electromagnetic door holders are commonly used in commercial buildings to release doors when, for example, fire alarms go off. A common type of electromagnetic door holder is a wall mounted electromagnetic door holder. A catch plate is mounted to the door, and swivelled to align the catch plate with the electromagnetic door holder. The electromagnetic door holder is attached to the wall in a position to contact the catch plate when the door is fully open. The electromagnetic door holder is energized to hold the catch plate, and thereby hold the door in the open position. When electricity to the electromagnetic door holder is removed, the catch plate is released, and the door may close.

Unfortunately, such electromagnetic door holders generally reside in areas subjected to moisture. For example, door holders are often used near an exit or in an outdoor application where rain water, or irrigation water, may reach the electromagnetic door holder. An electrical failure of the electromagnetic door holder may result from such exposure to moisture.

### BRIEF SUMMARY OF THE INVENTION

The present invention addresses the above and other needs by providing a moisture resistant electromagnetic door holder which is sealed to avoid failures caused by exposure to moisture. The electromagnetic door holder comprises a wall box, a coil housing attached to the wall box, and a coil assembly attached to the coil housing. The coil assembly includes a bobbin containing a wire coil. A sealant, preferably epoxy, covers the face of the bobbin to prevent moisture from entering the coil assembly. A seal may be incorporated between a coil passage in the coil housing and the coil assembly. A gasket resides between the coil housing and the wall box. The resulting the electromagnetic door holder resists the entry of moisture into the electromagnetic door holder and thereby improves the reliability of the electromagnetic door holder

In accordance with one aspect of the invention, there is provided a moisture resistant electromagnetic door holder comprising a wall box, a coil housing attached to the wall box, and a sealed coil assembly attached to the coil housing and having an exposed face. The coil housing includes a coil passage and the coil assembly resides in the coil passage. A coil O-Ring resides between the coil housing and the coil assembly to prevent moisture from entering the electromagnetic door holder through the coil passage.

In accordance with another aspect of the invention, there is provided a moisture resistant electromagnetic door holder comprising a wall box, a coil housing attached to the wall box, and a sealed coil assembly attached to the coil housing and having an exposed face. The coil assembly comprises a bobbin and a coil housing, and the bobbin resides in the coil housing. A sealing material resides over an otherwise exposed surface of the bobbin to prevent moisture from entering the coil assembly through the bobbin.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a door held open by a wall mounted electromagnetic door holder.

FIG. 2 shows a wall box, gasket, coil housing, and coil assembly of a wall mounted door holder according to the present invention.

FIG. 3 is a front view of the wall box.

FIG. 4 is a front view of the gasket.

FIG. 5A is a side view of the coil assembly detached from the coil housing.

FIG. 5B is a side view of the coil assembly attached to the coil housing.

FIG. 6 is a cross-sectional view of the coil assembly taken along line 6-6 of FIG. 5B.

FIG. 7A shows a side view of the coil assembly.

FIG. 7B shows a front view of the coil assembly.

FIG. 8 is a cross-sectional view of the coil assembly taken along line 8-8 of FIG. 7B.

FIG. 9 is an exploded perspective view of the coil assembly.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

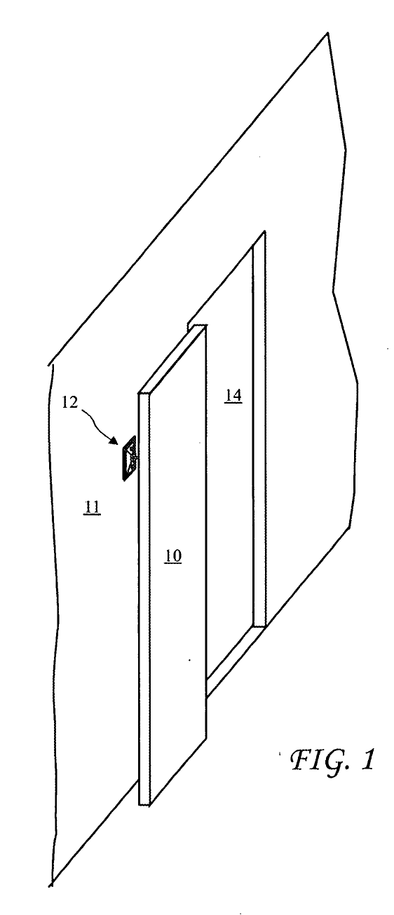

A door 10 held open by an electromagnetic door holder 12 mounted to a wall 11 is shown in FIG. 1. The electromagnetic door holder 12 holds the door 10 open as long as power is provided to the electromagnetic door holder 12. In the case of fire, or some other triggering event, power is removed, and the electromagnetic door holder 12 releases the door 10 to close in the doorway 14. The wall 11 may be an exterior wall, or the doorway 14 may be an exterior doorway, and as a result, the electromagnetic door holder 12 may be exposed to rain, sprinklers, or other moisture sources.

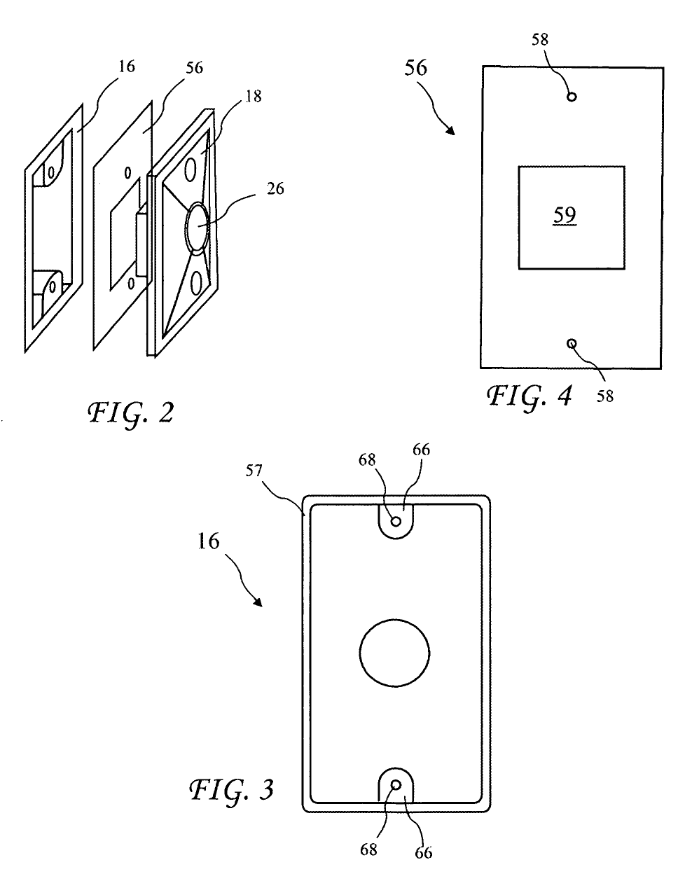

An exploded view of a wall box 16, gasket 56, coil housing 18, and coil assembly 26 is shown in FIG. 2. The wall box 16 is a common wall box used for light switches, power outlets, and the like. The gasket 56 is preferably made from closed cell foam, and provide resistance to moisture entering the wall box 16. A front view of the wall box 16 is shown in FIG. 3. The wall box 16 includes screw bosses 66 having screw receptacles 68 for attaching the coil housing 18 to the wall box 16, and an out edge which cooperates with the gasket 56 to resist the entry of moisture into the wall box 16. A front view of the gasket 56 is shown in FIG. 4. The gasket 56 includes screw passages 58 and a gasket coil passage 59.

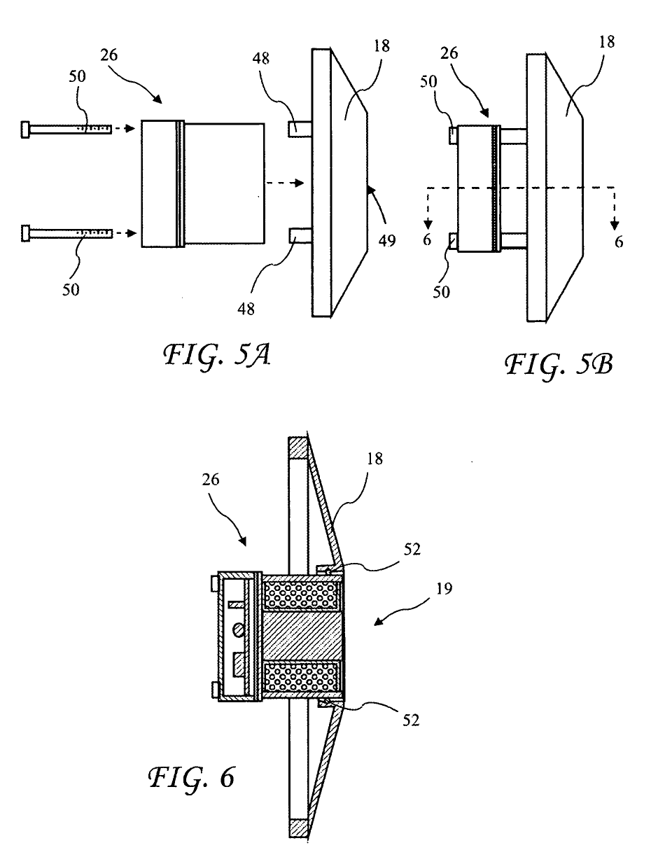

The coil housing 18 and the coil assembly 26 are shown prior to assembly in FIG. 5A, and the coil housing 18 and the coil assembly 26 are shown after assembly in FIG. 5B. The coil housing 18 includes coil posts 48 for attachment of the coil assembly 26 to the coil housing 18 using coil assembly screws 50.

A cross-sectional view of the assembled coil housing 18 and the coil assembly 26 taken along line 6-6 of FIG. 5B is shown in FIG. 6. The coil assembly 26 resides in a housing coil passage 49 (see FIG. 5A). A coil passage seal 52 resides between the coil assembly 26 and the housing coil passage 49, thereby resisting the entry of moisture into the door holder 12, and preferably preventing the moisture from passing between the coil housing 18 and the coil assembly 26 and into the door holder 12. The coil passage seal 52 is preferably an O-Ring residing partially in an O-Ring groove in the passage 49, but may be a gasket, a mastic, a silicon sealer, or any suitable moisture sealing material. The O-Ring may alternatively or additionally reside partially in an O-Ring groove on the exterior of the coil housing 28.

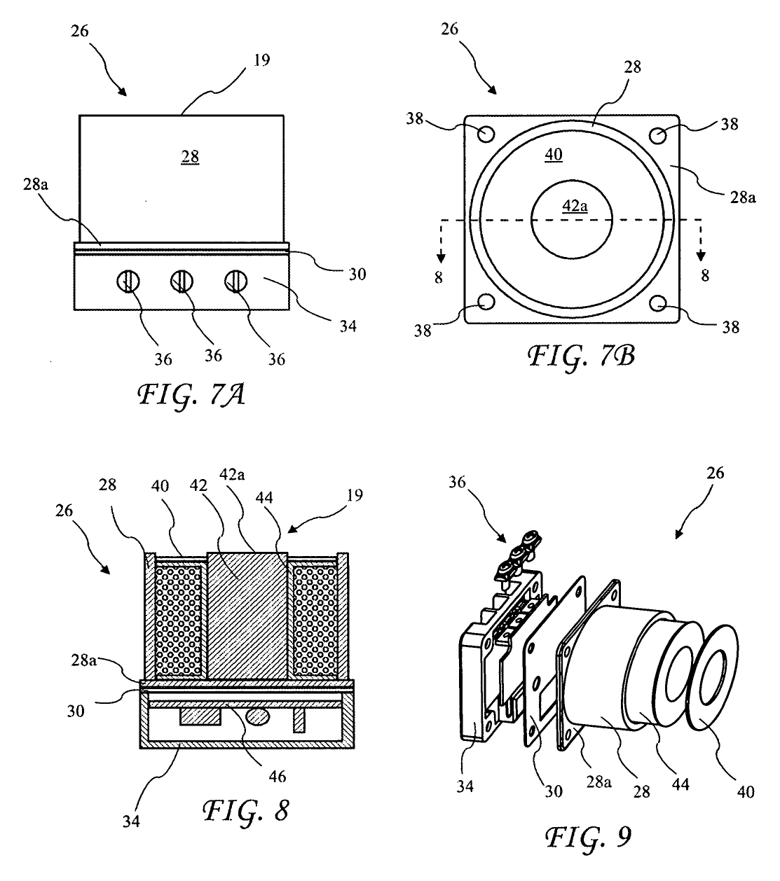

A side view of the coil assembly 26 according to the present invention is shown in FIG. 7A and a top view of the coil assembly 26 is shown in FIG. 7B. The coil assembly 26 includes three electrical terminals 36 for connecting a power source to the coil assembly 26. The coil assembly preferably receives a power signal between 12 and 24 Volts Direct Current (VDC) or between 24 and 120 Volts Alternating Current (VAC) to energize the coil. Four coil screw passages 38 are provided in the base portion 28a for attaching the coil assembly 26 to the coil housing 18 (FIG. 2A). A coil insulator 30 resides between the coil housing 28 and a circuit housing 34. The three electrical terminals 36 preferably reside on the exterior of the circuit housing 34.

A cross-sectional view of the coil assembly taken along ling 8-8 of FIG. 7B is shown in FIG. 8. The coil face 19 comprises a coil seal 40 residing over a bobbin 44, and an exposed core face 42a of a coil core 42, wherein the seal 40 preferably resides in a gap between the exposed core face 42a and the coil housing 28. The seal 40 resists the entry of moisture into the coil assembly 26, and preferably prevents the entry of moisture into the coil assembly 26. The seal 40 is preferably an epoxy seal. A Printed Circuit (PC) board 46 resides in the circuit housing 34.

An exploded perspective view of the coil assembly 26 is shown in FIG. 9. The coil assembly 26 comprises a circuit housing 34 containing a circuit, terminals 36 for making electrical connections with the circuit, a coil insulator 30, a coil housing 28 having a base portion (or flange) 28a, a bobbin 44 residing in the coil housing 28, and a coil seal 40.

While the invention herein disclosed has been described by means of specific embodiments and applications thereof, numerous modifications and variations could be made thereto by those skilled in the art without departing from the scope of the invention set forth in the claims.

I claim:

1. A moisture resistant electromagnetic door holder comprising:
a wall box configured for mounting in a wall;
a coil housing attachable to the wall box
a coil assembly attachable to the coil housing and having an exposed face; and
a coil seal on the exposed face of the coil assembly to resist moisture entering the coil assembly.

2. The moisture resistant electromagnetic door holder of claim 1, wherein:
the coil assembly includes a bobbin in a coil housing; and
the coil seal comprises a sealing material residing over an otherwise exposed surface of the bobbin.

3. The moisture resistant electromagnetic door holder of claim 2, wherein:
the coil assembly further includes a coil core;
the bobbin resides between the coil core and the coil housing; and
the sealing material resides in a gap between an exposed core face of the coil core and the coil housing.

4. The moisture resistant electromagnetic door holder of claim 1, wherein the coil housing includes a coil passage and the coil assembly resides in the coil passage, and a moisture resistant coil seal resides between the coil housing and the coil assembly.

5. The moisture resistant electromagnetic door holder of claim 4, wherein the coil seal is a coil O-Ring residing between the coil assembly and the coil housing.

6. The moisture resistant electromagnetic door holder of claim 5, wherein the coil passage includes a coil O-Ring groove the coil O-Ring at least partially resides in the coil O-Ring groove.

7. The moisture resistant electromagnetic door holder of claim 1, further including a gasket configured to reside between the coil housing and the wall box to resist the entry of moisture into the wall box.

8. The moisture resistant electromagnetic door holder of claim 7, wherein the gasket is made from close cell foam.

9. The moisture resistant electromagnetic door holder of claim 7, wherein the gasket includes a gasket coil passage and screw passages.

10. A moisture resistant electromagnetic door holder comprising:
a wall box mounted to a wall;
a coil housing attached to the wall box;
a sealed coil assembly residing in a coil passage in the coil housing and having an exposed face; and
a coil O-Ring residing in the coil passage between the coil housing and the coil assembly.

11. The moisture resistant electromagnetic door holder of claim 10, wherein:
the coil assembly includes a bobbin and a coil housing;
the bobbin resides in the coil housing; and
a sealing material resides over an otherwise exposed surface of the bobbin.

12. The moisture resistant electromagnetic door holder of claim 11, wherein:
the coil assembly further includes a coil core;
the bobbin resides between the coil core and the coil housing; and
the sealing material resides in a gap between an exposed core face of the coil core and the coil housing.

13. The moisture resistant electromagnetic door holder of claim 10, wherein a gasket resides between the coil housing and the wall box to resist the entry of moisture into the wall box.

14. A moisture resistant electromagnetic door holder comprising:
a wall box;
a coil housing attached to the wall box and including a coil passage;
a gasket between the wall box and the coil housing;
a coil assembly residing in the coil passage, the coil assembly having a bobbin with an exposed face, a sealing material residing over the exposed face of the bobbin; and
a coil passage seal residing between the coil assembly and the coil passage to resist the passage of moisture between the coil assembly and the coil passage.

15. The moisture resistant electromagnetic door holder of claim 14, wherein the coil passage seal comprises a coil O-Ring resides between the coil passage and the coil assembly.

16. The moisture resistant electromagnetic door holder of claim 15, wherein the coil O-Ring resides between the coil passage and the coil assembly and partially within an O-Ring groove in the coil passage.

17. The moisture resistant electromagnetic door holder of claim 15, wherein:
the coil assembly includes a coil housing; and
the coil O-Ring resides between the coil passage and the coil assembly and partially within an O-Ring groove on the exterior of the coil housing.
